(19) United States
(12) Patent Application Publication
(10) Pub. No.: US 2013/0066468 A1
(43) Pub. Date: Mar. 14, 2013

(54) TELEPRESENCE ROBOT, TELEPRESENCE SYSTEM COMPRISING THE SAME AND METHOD FOR CONTROLLING THE SAME

(71) Applicants: Mun-Taek Choi, Uijeongbu-si (KR); MunSang Kim, Seoul (KR); InJun Park, Yeoju-gun (KR); Chang Gu Kim, Namyangju-si (KR); Jin Hwan Yoo, Seoul (KR); YoungHo Lee, Anyang-si (KR); Juk Kyu Hwang, Seoul (KR); Richard H. Shinn, Seoul (KR)

(72) Inventors: Mun-Taek Choi, Uijeongbu-si (KR); MunSang Kim, Seoul (KR); InJun Park, Yeoju-gun (KR); Chang Gu Kim, Namyangju-si (KR); Jin Hwan Yoo, Seoul (KR); YoungHo Lee, Anyang-si (KR); Juk Kyu Hwang, Seoul (KR); Richard H. Shinn, Seoul (KR)

(73) Assignee: KOREA INSTITUTE OF SCIENCE AND TECHNOLOGY, Seoul (KR)

(21) Appl. No.: 13/634,163

(22) PCT Filed: Aug. 19, 2010
(86) PCT No.: PCT/KR2010/005491

§ 371 Date: Nov. 23, 2012

(30) Foreign Application Priority Data
Mar. 11, 2010 (KR) 10-2010-0021668

(51) Int. Cl. B25J 5/00; B25J 13/08

(52) U.S. Cl. 700/258; 901/1; 901/46

(57) ABSTRACT

A telepresence robot may include a manual navigation unit configured to move the telepresence robot according to navigation information received from a user device; an autonomous navigation unit configured to detect environment of the telepresence robot and control the movement of the telepresence robot using the detected result; a motion control unit comprising a database related to at least one motion, the motion control unit configured to receive selection information on the motion of the database and actuate the telepresence robot according to the selection information; and an output unit configured to receive expression information of a user from the user device and output the expression information. The telepresence robot may be applied to various fields such as language education by a native speaking teacher, medical diagnoses, teleconferences, or remote factory tours.

### TECHNICAL FIELD

This disclosure relates to a telepresence robot, a telepresence system comprising the same and a method for controlling the same.

### BACKGROUND ART

Telepresence refers to a series of technologies which allow users at a remote location to feel or operate as if they were present at a place other than their actual location. In order to implement the telepresence, sensory information which are experienced by the users when they are actually positioned at the corresponding place is0020necessarily communicated to the users at the remote location. Furthermore, it is possible to allow the users to have influence on a place other than their actual location by sensing the movements or sounds of the users at the remote location and reproducing them at the place other than their actual location.

### DISCLOSURE

### Technical Problem

Embodiments provide a telepresence robot which can navigate in a hybrid fashion of the manual operation controlled by a user at a remote location and the autonomous navigation of the telepresence robot. The user can easily control the operation of the telepresence robot corresponding to various expressions through a graphic user interface (GUI). Embodiments also provide a telepresence system comprising the same and a method for controlling the same.

### Technical Solution

In one embodiment, the telepresence robot includes: a manual navigation unit configured to move the telepresence robot according to navigation information received from a user device; an autonomous navigation unit configured to detect environment of the telepresence robot and control the movement of the telepresence robot using the detected result; a motion control unit comprising a database related to at least one motion, the motion control unit configured to receive selection information on the motion of the database and actuate the telepresence robot according to the selection information; and an output unit configured to receive expression information of a user from the user device and output the expression information.

In one embodiment, the telepresence system includes: a telepresence robot configured to move using navigation information and detection result of environment, the telepresence robot comprising a database related to at least one motion, and is configured to be actuated according to selection information on the motion of the database and output expression information of a user; a user device configured to receive the navigation information and the selection information, transmit the navigation information and the selection information to the telepresence robot, and transmit the expression information to the telepresence robot; and a recording device configured to transmit visual information and/or auditory information of the environment of the telepresence robot to the user device.

In one embodiment, the method for controlling the telepresence robot includes: receiving navigation information at the telepresence robot from a user device; moving the telepresence robot according to the navigation information; detecting environment of the telepresence robot and moving the telepresence robot according to the detected result; receiving selection information on motion at the telepresence robot from the user device, wherein the selection information is based on a database related to at least one motion of the telepresence robot; actuating the telepresence robot according to the selection information; receiving expression information of a user at the telepresence robot and outputting the expression information; and transmitting auditory information and/or visual information of the environment of the telepresence robot to the user device.

In another embodiment, the method for controlling the telepresence robot includes: receiving navigation information of the telepresence robot at a user device; transmitting the navigation information to the telepresence robot; receiving selection information on motion of the telepresence robot at the user device based on a database related to at least one motion of the telepresence robot; transmitting the selection information to the telepresence robot; transmitting expression information of a user to the telepresence robot; and receiving auditory information and/or visual information of environment of the telepresence robot and outputting the auditory information and/or visual information.

### Advantageous Effects

Using the telepresence robot according to example embodiments as an assistant robot for teaching languages, a native speaking teacher at a remote location can easily interact with learners through the telepresence robot. Also, the native speaking teacher can easily control various motions of the telepresence robot using a graphic user interface (GUI) based on an extensible markup language (XML) message. Accordingly, education concentration can be enhanced and labor costs can be saved, as compared with the conventional language learning scheme which is dependent upon a limited number of native speaking teachers. A telepresence robot and a telepresence system comprising the same according to example embodiments can also be applied to various other fields such as medical diagnoses, teleconferences, or remote factory tours.

### DESCRIPTION OF DRAWINGS

The above and other objects, features and advantages disclosed herein will become apparent from the following description of particular embodiments given in conjunction with the accompanying drawings.

FIG. 1 is a block diagram showing the configuration of a telepresence robot according to an example embodiment.

FIG. 2 is a perspective view schematically showing the shape of a telepresence robot according to an example embodiment.

FIG. 3 is view schematically showing the layout of a classroom to which a telepresence system according to an example embodiment is applied.

FIG. 4 is a schematic perspective view of a head mount type device included in a user device in a telepresence system according to an example embodiment.

FIG. 5 is a view exemplarily showing a graphic user interface (GUI) of a user device in a telepresence system according to an example embodiment.

FIG. 6 is a flowchart illustrating a method for controlling a telepresence robot according to an example embodiment.

### MODE FOR INVENTION

Embodiments are described herein with reference to the accompanying drawings. Principles disclosed herein may, however, be embodied in many different forms and should not be construed as being limited to the embodiments set forth herein. In the description, details of well-known features and techniques may be omitted to avoid unnecessarily obscuring the features of the embodiments.

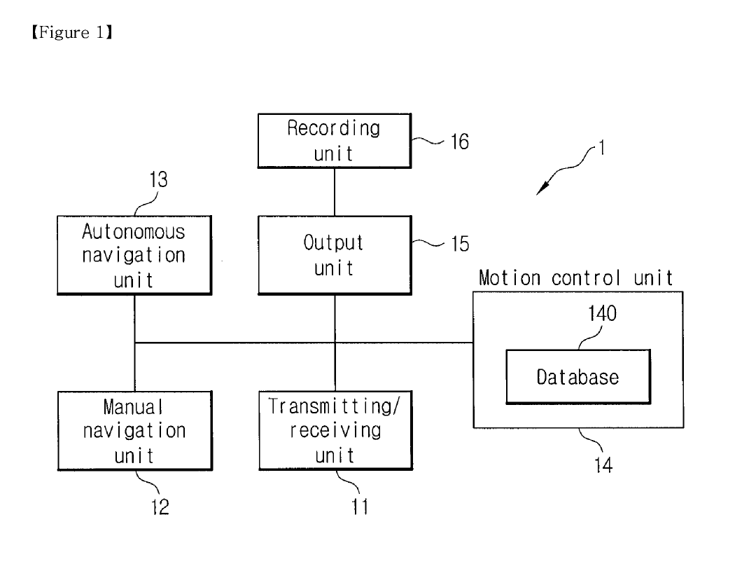

FIG. 1 is a block diagram showing the configuration of a telepresence robot according to an example embodiment.

The telepresence robot 1 according to the example embodiment can be easily operated by a user at a remote location using a graphic user interface (GUI). Further, the telepresence robot can output voice and/or image information of the user and/or reproduce facial expression or body motion of the user. Furthermore, the telepresence robot can communicate auditory and/or visual information of the environment around the telepresence robot 1 to the user. For example, the telepresence robot 1 may be applied to a teaching assistance for a language teacher. A native speaking teacher at a remote location may interact with learners through the telepresence robot 1, so that it is possible to implement a new form of language education.

In this disclosure, the technical spirit disclosed herein will be described based on an example in which the telepresence robot is applied to a teaching assistance for a native speaking teacher. However, applications of the telepresence robot according to example embodiments are not limited to the aforementioned application but may be used in various other fields such as medical diagnoses, teleconferences, or remote factory tours.

The telepresence robot 1 according to the example embodiment may include a manual navigation unit 12, an autonomous navigation unit 13, a motion control unit 14, an output unit 15 and a recording unit 16. In this disclosure, a unit, system or the like may refer to hardware, combination of hardware and software, or software which is driven by using the telepresence robot as a platform or communicating with the telepresence robot. For example, the unit or system may refer to a process being executed, a processor, an object, an executable file, a thread of execution, a program, or the like. Also, both of an application and a computer for executing the application may be the unit or system.

The telepresence robot 1 may include a transmitting/receiving unit 11 for communicating with a user device (not shown) at a remote location. The transmitting/receiving unit 11 may communicate a signal or data with the user device in a wired and/or wireless mode. For example, the transmitting/receiving unit 11 may be a local area network (LAN) device connected to a wired/wireless router. The wired/wireless router may be connected to a wide area network (WAN) so that the data can be communicated with the user device. Alternatively, the transmitting/receiving unit 11 may be directly connected to the WAN to communicate with the user device.

The manual navigation unit 12 moves the telepresence robot according to navigation information inputted to the user device. A native speaking teacher using the GUI implemented in the user device inputs the navigation information of the telepresence robot, so that the telepresence robot can be moved to a desired position. For example, the native speaking teacher may directly specify the movement direction and distance of the telepresence robot or move the telepresence robot by selecting a specific point on a map. Alternatively, when the native speaking teacher selects a specific motion of the telepresence robot, the telepresence robot may be moved to a position predetermined with respect to the corresponding motion. As an example, if the native speaking teacher selects the start of a lesson in the GUI, the telepresence robot may be moved to the position at which the lesson is started.

The autonomous navigation unit 13 detects environment of the telepresence robot and controls the movement of the telepresence robot according to the detected result. That is, the telepresence robot may navigate in a hybrid fashion that its movement is controlled by simultaneously using a manual navigation performed by the manual navigation unit 12 according to the operation by a user and an autonomous navigation performed by the autonomous navigation unit 13. For example, while the telepresence robot is moved by the manual navigation unit 12 based on navigation information inputted by a user, the autonomous navigation unit 13 may control the telepresence robot to detect an obstacle or the like in the environment of the telepresence robot and to stop or avoid the obstacle according to the detected result.

The motion control unit 14 actuates the telepresence robot according to a motion specified by a user. The motion control unit 14 may include a database 140 related to at least one predetermined motion. The database 140 may be stored in a storage built in the telepresence robot or stored in a specific address on a network accessible by the telepresence robot. At least one piece of actuation information corresponding to each motion may be included in the database 140. The telepresence robot may be actuated according to the actuation information corresponding to the motion selected by the user. The selection information of the user on each motion may be transmitted to the telepresence robot in the form of an extensible markup language (XML) message.

In this disclosure, the actuation information refers to one or plurality of combinations of templates which are expression units of the telepresence robot suitably selected for utterance or a series of motions of the telepresence robot. Through the actuation information, various motion styles can be implemented. Such motion styles can be implemented by independently controlling each physical object such as a head, an arm, a neck, an LED, a navigation unit (legs, wheels or the like) or an utterance unit of the telepresence robot through the actuation information that includes one or more combinations of templates.

For example, templates may be stored in the form of an XML file for each physical object (e.g., a head, an arm, a neck, an LED, a navigation unit, an utterance unit or the like), which constitutes the telepresence robot. Each of the templates may include parameters for controlling an actuator such as a motor for operating a corresponding physical object of the telepresence robot. As an example, each of the parameters may contain information including an actuation speed of the motor, an operating time, a number of repetitions, synchronization related information, a trace property, and the like.

The actuation information may include at least one of the templates. The telepresence robot actuated through the actuation information controls the operation of a robot's head, arm, neck, LED, navigation unit, voice utterance unit or the like based on each template and parameters included in each of the templates, thereby implementing a specific motion style corresponding to the actuation information. For example, when the telepresence robot is actuated based on the actuation information corresponding to “praise,” it may be configured to output a specific utterance for praising a learner and perform a gesture of putting its hand up at the same time.

In an example embodiment, a plurality of pieces of actuation information may be defined with respect to one motion, and the telepresence robot may arbitrarily perform any one of actuations corresponding to a selected motion. Through the configuration described above, the expression of the telepresence robot on a motion can be variously implemented, and it is possible to eliminate the monotony of repetition, felt by learners who face the telepresence robot.

In an example embodiment, motions of the telepresence robot, included in the database 140, a display corresponding to each of the motions on the GUI, and the number of pieces of actuation information corresponding to each of the motions are shown in the following table.

TABLE 1

| | | Number of pieces of |
|---|---|---|
| | Display on GUI of User | corresponding actuation |
| Kind of Motion | Device | information |
| Praise | Praise | 10 |
| Disappointment | Disappointed | 10 |
| Happy | Happy | 10 |
| Sadness | Sad | 10 |
| Greeting | Hi/Bye | 10 |
| Continuity | Keep going | 1 |
| Monitor instruction | Point to the monitor | 1 |
| Start | Let's start | 1 |
| Encouragement | Cheer up | 10 |
| Wrong answer | Wrong | 10 |
| Correct answer | Correct | 10 |

However, Table 1 shows an example of the implementation of the database 140 when the telepresence robot is applied to a language teaching assistant robot. The kind and number of motions that may be included in the database 140 of the telepresence robot are not limited to Table 1.

The output unit 15 receives expression information of the user from the user device and outputs the received expression information. In an example embodiment, the expression information may include voice and/or image information (e.g., a video with sounds) of a native speaking teacher. Voices and/or images of the native speaking teacher at a remote location may be displayed through the output unit 15, thereby improving the quality of language learning. In this regard, the output unit 15 may include a liquid crystal display (LCD), a monitor, speaker, or another appropriate image or voice output device.

In another example embodiment, the expression information may include actuation information corresponding to facial expression or body motion of the native speaking teacher. The user device may recognize user's facial expression or body motion and transmit actuation information corresponding to the recognized result as expression information to the telepresence robot. The output unit 15 may reproduce the facial expression or body motion of the user using the transmitted expression information, together with or in place of actual voice and/or image of the user outputted as they are.

For example, when the telepresence robot includes a mechanical face structure, the user device may transmit the result obtained by recognizing the facial expression of the native speaking teacher to the telepresence robot, and the output unit 15 may operate the face structure according to the transmitted recognition result. The output unit 15 may actuate a robot's head, arm, neck, navigation unit or the like according to the result obtained by recognizing the body motion of the native speaking teacher. Alternatively, the output unit 15 may display the facial expression or body motion of the native speaking teacher on the LCD monitor using an animation character or avatar.

When the user device recognizes the facial expression or body motion of the native speaking teacher and transmits the recognized result to the telepresence robot as described in the aforementioned example embodiment, it is unnecessary to transmit the actual voice and/or image of the native speaking teacher through a network. Accordingly, the transmission load can be reduced. However, the reproduction of the facial expression or body motion of the native speaking teacher in the telepresence robot may be performed together with the output of the actual voice and/or image of the native speaking teacher through the telepresence robot.

The recording unit 16 obtains visual and/or auditory information of the environment of the telepresence robot and transmits the obtained information to the user device. For example, voices and/or images of learners may be sent to the native speaking teacher at a remote location. In this regard, the recording unit 16 may include a webcam having a microphone therein or another appropriate recording device.

By using the telepresence robot according to the example embodiment, voice and/or image of a native speaking teacher at a remote location are outputted through the telepresence robot, and/or facial expression or body motion of the native speaking teacher are reproduced through the telepresence robot. Also, visual and/or auditory information of the environment of the telepresence robot is transmitted to the native speaking teacher. Accordingly, the native speaking teacher and learners can overcome the limitation of distance and easily interact with each other. The native speaking teacher may control the motion of the telepresence robot using the GUI implemented on the user device. In this case, various actuations of the telepresence robot may be defined with respect to one motion, so that it is possible to eliminate the monotony generated by repeating the same expression and to provoke the interest of the learners. By using the telepresence robot, learners in another region or country can learn from a native speaker, so that education concentration can be enhanced and labor costs can be saved, as compared with the conventional learning scheme which is dependent upon a limited number of native speaking teachers.

In an example embodiment, the motion control unit 14 may control the telepresence robot to autonomously perform predetermined actuations according to voice and/or image information of the native speaking teacher outputted through the output unit 15. For example, the motion control unit 14 may construct actuation information of the telepresence robot to be similar to body motions taken when a person utters, and stores the actuation information by corresponding it to a specific word or phrase. If the native speaking teacher utters a corresponding word or phrase and the corresponding voice is outputted to the output unit 15, the telepresence robot may perform a predetermined actuation corresponding to the word or phrase, so that it is possible to perform natural linguistic expression. When it is difficult to automatically detect the utterance section of the native speaking teacher, the motion of the telepresence robot may be manually performed by providing an utterance button on the GUI of the user device.

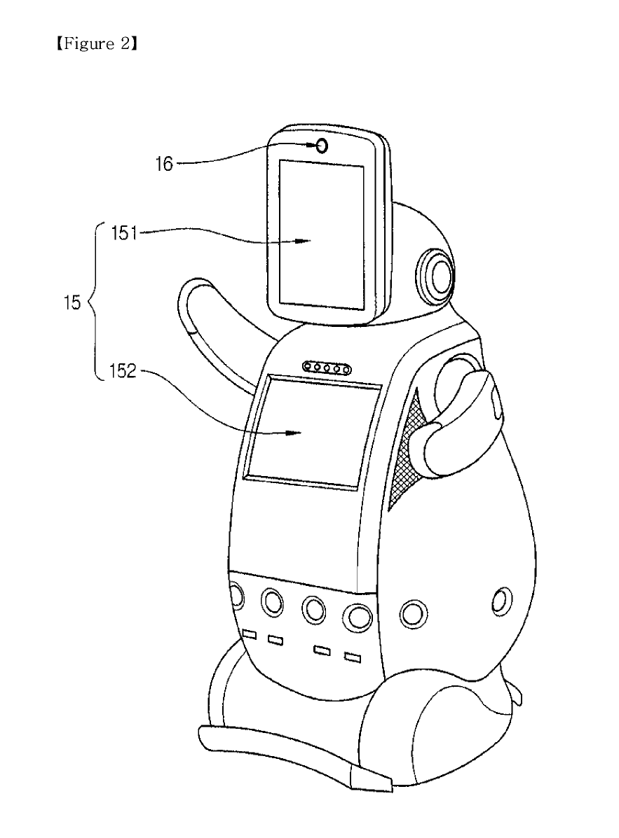

FIG. 2 is a perspective view schematically showing a shape of the telepresence robot according to an example embodiment.

Referring to FIG. 2, the telepresence robot may include LCD monitors 151 and 152 respectively disposed at a head portion and a breast portion. The two LCD monitors 151 and 152 correspond to the output unit 15. Images of a native speaking teacher may be displayed on the LCD monitor 151 at the head portion, and the LCD display monitor 151 may be rotatably fixed to a body of the telepresence robot. For example, the LCD monitor 151 at the head portion may be rotated at 90 degrees to the left/right thereof. The LCD monitor 152 at the breast portion may be configured to display a Linux screen for the purpose of the development of the telepresence robot. However, this is provided only for illustrative purposes. That is, other images may be displayed on the LCD monitor 152 at the breast portion, or the LCD monitor 152 at the breast portion may be omitted. A webcam which corresponds to the recording unit 16 is mounted at the upper portion of the LCD monitor 151 at the head portion so that a native speaking teacher can observe learners. The telepresence robot shown in FIG. 2 is provided only for illustrative purposes, and telepresence robots according to example embodiments may be implemented in other various forms.

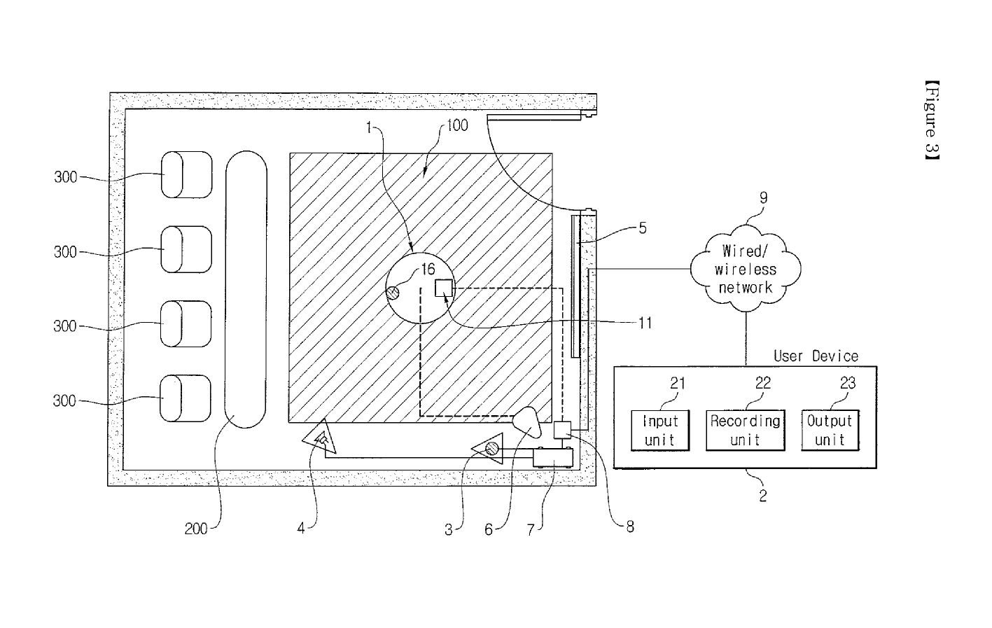

A telepresence system according to an example embodiment may include the telepresence robot described above. FIG. 3 is view schematically showing the layout of a classroom to which a telepresence system according to an example embodiment is applied. In the description of the example embodiment shown in FIG. 3, the configuration and operation of a telepresence robot 1 can be easily understood from the example embodiment described with reference to FIGS. 1 and 2, and therefore, the detailed description of the telepresence robot 1 will be omitted.

Referring to FIG. 3, the telepresence system may include a telepresence robot 1 and a user device 2. The telepresence robot 1 may be movably disposed at a certain active area 100 in a classroom. For example, the active area may be a square space of which one side has a length of about 2.5 m. However, the shape and size of the active area 100 is not limited thereto but may be properly determined in consideration of the usage of the telepresence robot 1, a navigation error, and the like. A microphone/speaker device 4, a television 5 and the like, which help with a lesson, may be disposed in the classroom. As an example, the television 5 may be used to display contents for lesson, and the like.

A desk 200 and chairs 330 may be disposed adjacent to the active area 100 of the telepresence robot 1, and learners may face the telepresence robot 1 while sitting on the chairs 300. The desk 200 may be one with a screened front so that the telepresence robot 1 is actuated only in the active area 100 using a sensor. Alternatively, the active range of the telepresence robot 1 may be limited by putting a bump between the active area 100 and the desk 200.

The telepresence robot 1 and the user device 2 may communicate with each other through a wired/wireless network 9. For example, the telepresence robot 1 may be connected to a personal computer (PC) 7 and a wired/wireless router 8 through a transmitting/receiving unit 11 such as a wireless LAN device. The wired/wireless router 8 may be connected to the network 9 such as WAN through a wired LAN so as to communicate with the user device through the network 9. In an example embodiment, the transmitting/receiving unit 11 of the telepresence robot 1 may be directly connected to the network 9 so as to communicate with the user device 2.

The user device 2 may include an input unit 21 to which an operation performed by a native speaking teacher is inputted; a recording unit 22 that obtains expression information including voice and/or image information of the native speaking teacher, actuation information corresponding to facial expression or body motion of the native speaking teacher and then transmits the expression information to the telepresence robot 1; and an output unit 23 that outputs auditory and/or visual information of learners received from the telepresence robot 1. The input unit 21, the recording unit 22 and the output unit 23 in the user device 2 may refer to a combination of software executed on computers and hardware for executing the software. For example, the user device 2 may include a computer with a webcam and/or a head mount type device.

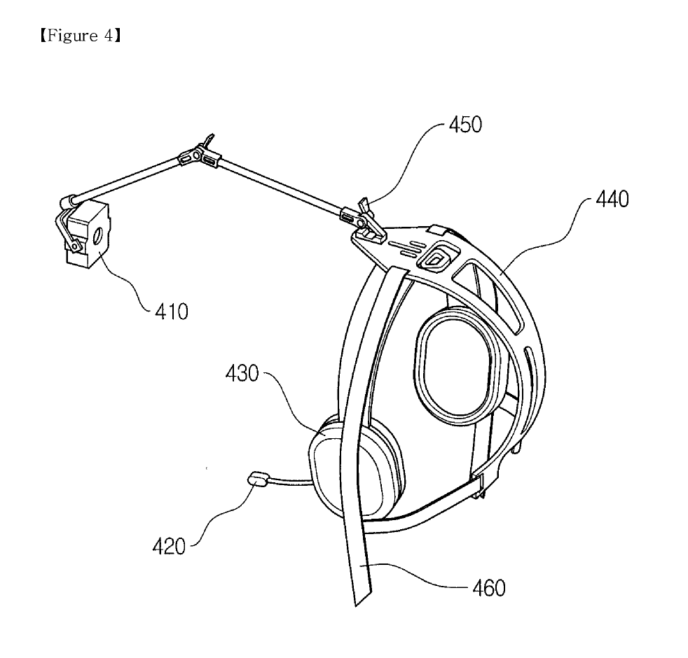

FIG. 4 is a schematic perspective view of a head mount type device included in a user device in a telepresence system according to an example embodiment.

Referring to FIG. 4, the head mount type device may include a webcam 410 and a microphone 420 so as to obtain face image and voice of a native speaking teacher. The webcam 410 may be connected to a fixed plate 440 through an angle adjusting unit 450 that adjusts the webcam 410 to a proper position based on the face shape of the native speaking teacher. The head mount type device may be fixed to the face of the native speaking teacher by a chin strap 460. Also, a headphone 430 that outputs voices of learners to the native speaking teacher may be included in the head mount type device.

A native speaking teacher may remotely perform a lesson using a computer (not shown) having a monitor together with the head mount type device. Images and voices of the native speaking teacher are obtained through the webcam 410 and the microphone 420, respectively, and the obtained images and voices are transmitted to the learners so as to be outputted through the telepresence robot. Since the webcam 410 is mounted on a head portion of the native speaking teacher, the face of the native speaking teacher is always maintained as the front to the learners regardless of the direction of the native speaking teacher, thereby maintaining realism. Also, images of the learners may be outputted to an image output device of the computer, and voices of the learners may be sent to the native speaking teacher through a headphone 430 of the head mount type device.

The head mount type device shown in FIG. 4 is illustratively shown as a partial configuration of the user device that receives voices and/or images of the native speaking teacher and outputs voices of the learners. The user device may be a different type device of which some components are omitted, modified or added from the head mount type device shown in FIG. 4. For example, a unit that outputs images of the learners may be included in the head mount type device.

Referring back to FIG. 3, a charger 6 may be disposed at one side in the active area 100 of the telepresence robot. The telepresence robot 1 may be charged by moving to a position adjacent to the charger 6 before a lesson is started or after the lesson is ended. For example, if the native speaking teacher indicates the end of the lesson using the user device 2, the telepresence robot may be moved to the position adjacent to the charger 6. Also, if the native speaking teacher indicates the start of the lesson using the user device 2, the telepresence robot 1 may be moved to a predetermined point in the active area 100. Alternatively, the movement of the telepresence robot 1 may be manually controlled by the native speaking teacher.

The telepresence system according to an example embodiment may include a recording device for transmitting visual and/or auditory information of the environment of the telepresence robot 1 to the user device 2. For example, the telepresence system may include a wide angle webcam 3 fixed to one wall of the classroom using a bracket or the like. In an example embodiment, the native speaking teacher at a remote location may observe several learners using the wide angle webcam fixed to the wall of the classroom in addition to the webcam mounted in the telepresence robot 1. In another example embodiment, the lesson may be performed only using the wide angle webcam 3 without the webcam mounted in the telepresence robot 1.

In the telepresence system according to an example embodiment, a webcam that sends images of the learners to the native speaking teacher and a monitor that outputs images of the native speaking teacher to the learners may be built in the telepresence robot, but a device that transmits/receives voices between the learners and the native speaking teacher may be configured separately from the telepresence robot. For example, a wired or wireless microphone/speaker device may be disposed at a position spaced apart from the telepresence robot so as to send voices of the learners to the native speaking teacher and to output voices of the native speaking teacher. Alternatively, each of the learners may transmit/receive voices with the native speaking teacher using a headset with a built-in microphone.

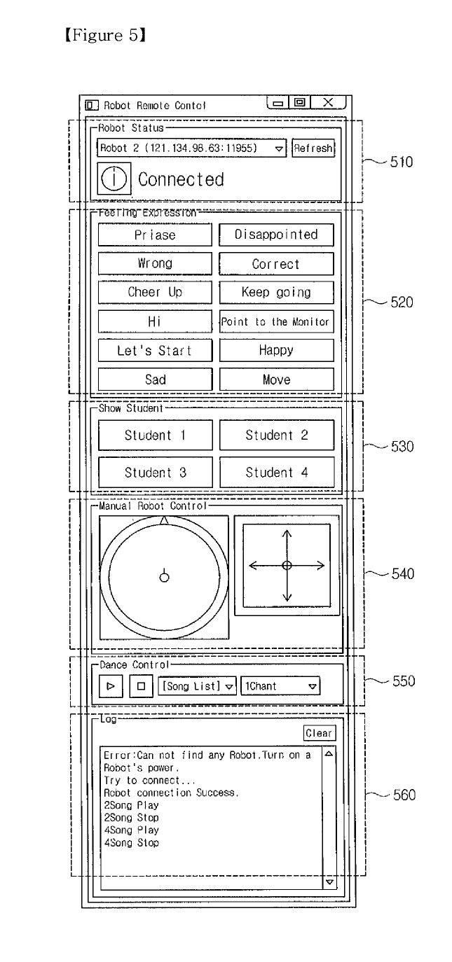

FIG. 5 is a view exemplarily showing a GUI of a user device in a telepresence system according to an example embodiment.

Referring to FIG. 5, the GUI presented to a native speaking teacher through the user device may include one or more buttons. The uppermost area 510 of the GUI is an area through which the state of the telepresence robot is displayed. The internet protocol (IP) address of the telepresence robot, the current connection state of the telepresence robot, and the like may be displayed in the area 510.

In the GUI, an area 520 includes buttons corresponding to at least one motion of the telepresence robot. If the native speaking teacher clicks and selects any one of buttons “Praise,” “Disappoint,” or the like, the telepresence robot performs the actuation corresponding to the selected motion. While one motion is being actuated by the telepresence robot, the selection of another motion may be impossible. The selection information on the motion of the telepresence robot may be transmitted in the form of an XML message to the telepresence robot.

In the GUI, buttons that allow the telepresence robot to stare at learners may be disposed in an area 530. The respective buttons in the area 530 correspond to each learner, and the position information of each of the learners (e.g., the position information of each of the chairs 300 in FIG. 3) may be stored in the telepresence robot. Therefore, if the native speaking teacher presses any one of the buttons in the area 530, the telepresence robot may stare at a corresponding learner.

In the GUI, an area 540 is an area through which the native speaking teacher manually controls the movement of the telepresence robot. The native speaking teacher may control the facing direction of the telepresence robot using a wheel positioned at the left side in the area 540, and the displacement of the telepresence robot may be controlled by clicking four directional arrows positioned at the right side in the area 540.

In the GUI, an area 550 allows the telepresence robot to perform actuations such as dancing to a song. If the native speaking teacher selects a chant or song by operating the area 550, the telepresence robot may perform a motion of dancing such as moving or operating arms, or the like, while the corresponding chant or song is outputted through the telepresence robot.

In the GUI, an area 560 is an area through which a log related to the communication state between the user device and the telepresence robot and the actuation of the telepresence robot is displayed.

The GUI of the user device described with reference to FIG. 5 is provided only for illustrative purposes. The GUI of the user device may be properly configured based on the usage of the telepresence robot, the kind of motion to be performed by the telepresence robot, the kind of hardware and/or operating system (OS) used in the user device, and the like. For example, one or more areas of the GUI shown in FIG. 5 may be omitted, or configurations suitable for other functions of the telepresence robot may be added.

In the telepresence system according to the aforementioned example embodiment, the native speaking teacher inputs operational information using the GUI of the user device. However, this is provided only for illustrative purposes. That is, in telepresence systems according to example embodiments, the user device may receive an input of the native speaking teacher using other appropriate methods other than the GUI. For example, the user device may be implemented using a multimodal interface (MMI) that is operated by recognizing voices, facial expression or body motion of the native speaking teacher.

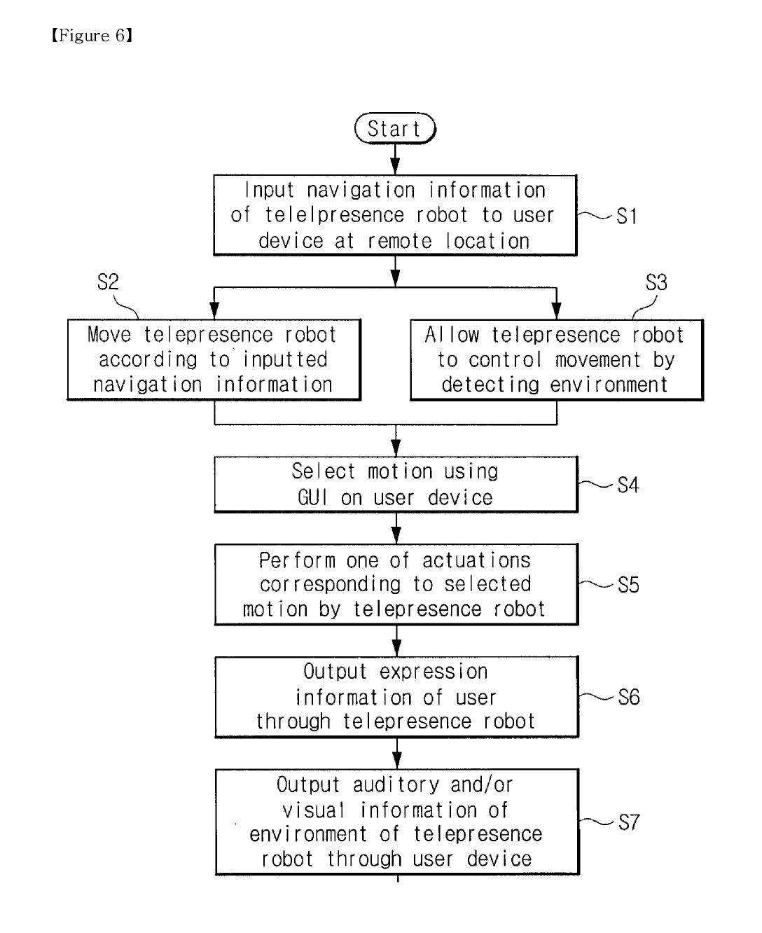

FIG. 6 is a flowchart illustrating a method for controlling a telepresence robot according to an example embodiment. For convenience of illustration, a method for controlling the telepresence robot according to the example embodiment will be described with reference to FIGS. 3 and 6.

Referring to FIGS. 3 and 6, navigation information of the telepresence robot may be inputted by a native speaking teacher (S1). The native speaking teacher may input the navigation information of the telepresence robot by specifying the movement direction of the telepresence robot using the GUI implemented on the user device or by selecting a point to be moved on a map. In an example embodiment, when the native speaking teacher selects a specific motion such as the start or end of a lesson, the telepresence robot may be moved to a predetermined position with respect to the corresponding motion.

Then, the telepresence robot may be moved based on the inputted navigation information (S2). The telepresence robot may receive the navigation information inputted to the user device through a network and move according to the received navigation information. Also, during the movement of the telepresence robot, the telepresence robot may control the movement by automatically detecting environment (S3). For example, the telepresence robot may perform a motion of autonomously avoiding an obstacle while being moved to a point specified by the native speaking teacher. That is, the movement of the telepresence robot may be performed by simultaneously using a manual navigation based on the operation of a user and an autonomous navigation.

Further, the native speaking teacher may select a motion to be performed by the telepresence robot using the GUI implemented on the user device (S4). The telepresence robot may include a database related to at least one motion, and the GUI of the user device may be implemented in accordance with the database. For example, in the GUI of the user device, each of the motions may be displayed in the form of a button. If a user selects a motion using the GUI, selection information corresponding to the selected motion may be transmitted to the telepresence robot. In an example embodiment, the selection information may be transmitted in the form of an XML message to the telepresence robot.

Subsequently, the actuation corresponding to the motion selected by the user may be performed using the database (S5). Herein, the actuation information of the telepresence robot, corresponding to one motion, may be configured as a plurality of pieces of actuation information, and the telepresence robot may perform any one of actuations corresponding to the selected motion. Through such a configuration, learners using the telepresence robot experience various expressions with respect to one motion, thereby eliminating the monotony of repetition.

Further, expression information of the native speaking teacher at a remote location may be outputted through the telepresence robot (S6). In an example embodiment, the expression information may include voice and/or image information of the native speaking teacher. In the user device, voice and/or image of the native speaking teacher may be obtained using a webcam with a microphone, or the like, and the obtained voice and/or image may be transmitted to the telepresence robot for outputting through the telepresence robot. In another example embodiment, the expression information may include actuation information of the telepresence robot, corresponding to facial expression or body motion of the native speaking teacher. In the user device, the facial expression or body motion of the native speaking teacher may be recognized, and the actuation information corresponding to the recognized facial expression or body motion may be transmitted to the telepresence robot. The telepresence robot may be actuated according to the received actuation information to reproduce the facial expression or body motion of the native speaking teacher, together with or in place of the output of actual voice and/or image of the native speaking teacher.

Furthermore, auditory and/or visual information of the environment of the telepresence robot may be transmitted to the user device to be outputted through the user device (S7). For example, voices and images of the learners may be transmitted to the user device of the native speaking teacher using the webcam in the telepresence robot, or the like.

In this disclosure, the method for controlling the telepresence robot according to the example embodiment has been described with reference to the flowchart shown in this figure. For brief description, the method is illustrated and described using a series of blocks. However, the order of the blocks is not particularly limited, and some blocks may be performed simultaneously or in a different order from the order illustrated and described in this disclosure. Also, various orders of other branches, flow paths and blocks may be implemented to achieve the identical or similar result. Further, all the blocks shown in this figure may not be required to implement the method described in this disclosure.

Although the example embodiments disclosed herein have been disclosed for illustrative purposes, those skilled in the art will appreciate that various modifications, additions and substitutions are possible, without departing from the scope and spirit of the disclosure as disclosed in the accompanying claims.

### INDUSTRIAL APPLICABILITY

This disclosure relates to a telepresence robot, a telepresence system comprising the same and a method for controlling the same.

1. A telepresence robot comprising:
a manual navigation unit configured to move the telepresence robot according to navigation information received from a user device;
an autonomous navigation unit configured to detect environment of the telepresence robot and control the movement of the telepresence robot using the detected result;
a motion control unit comprising a database related to at least one motion, the motion control unit configured to receive selection information on the motion of the database and actuate the telepresence robot according to the selection information; and
an output unit configured to receive expression information of a user from the user device and output the expression information.

2. The telepresence robot according to claim 1,
wherein the database comprises at least one piece of actuation information corresponding to each of the at least one motion, and
wherein the motion control unit is configured to actuate the telepresence robot according to any one of the at least piece of actuation information corresponding to the motion selected by the selection information.

3. The telepresence robot according to claim 1, wherein the expression information comprises image information and/or voice information of the user.

4. The telepresence robot according to claim 1,
wherein the expression information comprises actuation information corresponding to a facial expression or body motion of a user, and
wherein the output unit is configured to actuate the telepresence robot according to the expression information.

5. The telepresence robot according to claim 1, further comprising a recording unit configured to transmit auditory information and/or visual information of the environment of the telepresence robot to the user device.

6. The telepresence robot according to claim 1, further comprising a transmitting/receiving unit configured to communicate with the user device in a wired or wireless mode.

7. The telepresence robot according to claim 1, wherein the motion control unit is configured to actuate the telepresence robot using actuation information predetermined with respect to the expression information outputted through the output unit.

8. The telepresence robot according to claim 1, wherein the selection information is an extensible markup language (XML) message.

9. A telepresence system comprising:
a telepresence robot configured to move using navigation information and detection result of environment, the telepresence robot comprising a database related to at least one motion, and is configured to be actuated according to selection information on the motion of the database and output expression information of a user;
a user device configured to receive the navigation information and the selection information, transmit the navigation information and the selection information to the telepresence robot, and transmit the expression information to the telepresence robot; and
a recording device configured to transmit visual information and/or auditory information of the environment of the telepresence robot to the user device.

10. The telepresence system according to claim 9,
wherein the database comprises at least one piece of actuation information corresponding to each of the at least one motion, and
wherein the telepresence robot is configured to be actuated according to any one of the at least one piece of actuation information corresponding to the motion selected by the selection information.

11. The telepresence system according to claim 9, wherein the expression information comprises image information and/or voice information of the user.

12. The telepresence system according to claim 9,
wherein the expression information comprises actuation information corresponding to facial expression or body motion of the user, and
wherein the telepresence robot is configured to be actuated according to the expression information.

13. The telepresence system according to claim 9, wherein the recording device is mounted on the telepresence robot.

14. The telepresence system according to claim 9, wherein the user device comprises a head mount type device configured to be mounted on a head portion of the user.

15. The telepresence system according to claim 9, wherein the selection information is an XML message.

16. A method for controlling a telepresence robot, the method comprising:
receiving navigation information at the telepresence robot from a user device;
moving the telepresence robot according to the navigation information;
detecting environment of the telepresence robot and moving the telepresence robot according to the detected result;
receiving selection information on motion at the telepresence robot from the user device, wherein the selection information is based on a database related to at least one motion of the telepresence robot;
actuating the telepresence robot according to the selection information;
receiving expression information of a user at the telepresence robot and outputting the expression information; and
transmitting auditory information and/or visual information of the environment of the telepresence robot to the user device.

17. The method according to claim 16,
wherein the database comprises at least one piece of actuation information corresponding to each of the at least one motion, and
wherein actuating the telepresence robot according to the selection information comprises actuating the telepresence robot according to any one of the at least one piece of actuation information corresponding to the motion selected by the selection information.

18. The method according to claim 16, wherein the expression information comprises image information and/or voice information of the user.

19. The method according to claim 16,
wherein the expression information comprises actuation information corresponding to facial expression or body motion of the user, and
wherein outputting the expression information comprises actuating the telepresence robot according to the expression information.

20. The method according to claim 16, further comprising, after outputting the expression information, actuating the telepresence robot according to actuation information predetermined with respect to the expression information.

21. The method according to claim 16, wherein the selection information is an XML message.

22. A method for controlling a telepresence robot, the method comprising:
receiving navigation information of the telepresence robot at a user device;
transmitting the navigation information to the telepresence robot;
receiving selection information on motion of the telepresence robot at the user device based on a database related to at least one motion of the telepresence robot;
transmitting the selection information to the telepresence robot;
transmitting expression information of a user to the telepresence robot; and
receiving auditory information and/or visual information of environment of the telepresence robot and outputting the auditory information and/or visual information.

23. The method according to claim 22, wherein the expression information comprises image information and/or voice information of the user.

24. The method according to claim 22, wherein the expression information comprises actuation information of the telepresence robot corresponding facial expression or body motion of the user.

25. The method according to claim 22, wherein the selection information is an XML message.
